(19) United States
(12) Patent Application Publication
(10) Pub. No.: US 2008/0187776 A1
(43) Pub. Date: Aug. 7, 2008

(54) MULTILAYER SUBSTRATE

(75) Inventors: Ken Nakahara, Kyoto (JP); Hiroyuki Yuji, Kyoto (JP); Kentaro Tamura, Kyoto (JP); Shunsuke Akasaka, Kyoto (JP); Yoshio Nishimoto, Miyagi (JP); Masashi Kawasaki, Miyagi (JP); Akira Ohtomo, Miyagi (JP); Atsushi Tsukazaki, Miyagi (JP)

Correspondence Address: RABIN & Berdo, PC, 1101 14TH STREET, NW, SUITE 500, WASHINGTON, DC, 20005, US

(73) Assignee: ROHM CO., LTD., Kyoto-fu (JP)

(21) Appl. No.: 12/026,863

(22) Filed: Feb. 6, 2008

(30) Foreign Application Priority Data
Feb. 6, 2007 (JP) P2007-027183

(51) Int. Cl. B32B 15/00

(52) U.S. Cl. 428/656

(57) ABSTRACT

Provided is a multilayer substrate having the configuration in which a multilayer film is formed on a principal surface opposite to a principal surface in the oxide-thin-film lamination direction in a translucent substrate. The multilayer film is formed by sequentially laminating a dielectric film, Au (gold) film, and oxide film in this order from the translucent substrate. On the principal surface opposite to the principal surface on which the oxide thin film is disposed, the multilayer film containing the Au film is formed, the Au film can reflect and block the excessive infrared light from a substrate holder or a heat source at the time of growth. As a result, temperature can be accurately measured.

### CROSS REFERENCE TO RELATED APPLICATIONS AND INCORPORATION BY REFERENCE

This application is based upon and claims the benefit of prior Japanese Patent Application P2007-27183 filed on Feb. 6, 2007; the entire contents of which are incorporated by reference herein.

### BACKGROUND OF THE INVENTION

1. Field of the Invention

The present invention relates to a multilayer substrate for accurately measuring the temperature when crystal-growth is performed to form an oxide thin film on a translucent substrate transparent in an infrared region or when heat treatment is performed.

2. Description of the Related Art

As one type of laminated bodies of oxide thin films, for example, ZnO-based semiconductors are known. The ZnO-based semiconductors are expected to be employed in: ultraviolet LEDs, which are used as light sources for lightings, back lights, for example, high-speed electron devices; surface acoustic wave devices; or the like.

In general, a ZnO-based semiconductor is formed by crystal growth on a sapphire substrate or a ZnO-based substrate. The sapphire substrate is formed of aluminum oxide (Al₂O₃) and is known as a transparent substrate in the infrared wavelength region. In this manner, not only such ZnO-based semiconductor, but also other oxide thin films are formed on a translucent substrate. For example, Japanese Patent Application Publication No. 2000-327497 discloses that if crystal growth is carried out, control of growth temperature (substrate temperature) is of importance because the growth temperature affects the film quality, crystallinity, impurity concentration, and even composition ratio.

As described above, the substrate temperature of an oxide laminated body in which an oxide thin film is formed on a translucent substrate is monitored as described in FIG. 13. As shown in FIG. 13, a heat source 53, such as a heater, is disposed. If an oxide thin film is deposited on an oxide laminated body 52 mounted on (the lower side, in FIG. 13, of) a substrate holder 51, crystal growth is carried out by heating the laminate with the heather 53 to be a predetermined temperature. Meanwhile, the growth temperature is controlled by measuring the temperature (growth temperature or substrate temperature) of the oxide laminated body 52 per se by using an infrared thermometer (pyrometer) 54. The growth temperature is measured by receiving light of infrared light radiated from the oxide laminated body 52 by using the infrared thermometer 54.

Alternatively, as shown in FIG. 14, by using a substrate holder 55 configured so that heat radiation from the heat source 53 would not be blocked by the substrate holder and would be directly transmitted to the oxide laminated body 52, the substrate temperature of the oxide laminated body 52 can be measured by using the infrared thermometer 54.

However, with the configuration of the conventional art shown in FIG. 13, the translucent substrate and the oxide thin film deposited on the translucent substrate are transparent in almost all wavelength regions from the visible light region to the wavelength of approximately 8 μm. Thus, infrared light R2 (broken line) from the substrate holder 51 passes through the oxide laminated body 52. Accordingly, the infrared thermometer 54, which monitors infrared light R1 (solid line) showing the substrate temperature, receives not only the infrared light R1 but also the infrared light R2 from the substrate holder 51 behind the oxide laminated body 52. As a result, the infrared thermometer 54 cannot accurately measure the substrate temperature.

Meanwhile, with the configuration of the conventional art shown in FIG. 14, the substrate holder is absent on the back surface of the oxide laminated body 52. Accordingly, the infrared thermometer 54 does not receive the infrared light from the substrate holder 55 differing from the case described in FIG. 13. However, in this case, infrared light R3 (alternate long and short dash line) from the heat source 53 passes through the oxide laminated body 52 and enters into the infrared thermometer 54 together with the infrared light R1. Thus, there is a problem that the substrate temperature cannot be accurately measured. In addition, in the case where heat treatment (annealing processing) or annealing processing is carried out, the substrate temperature could not be accurately measured due to reasons similar to those described above. Incidentally, the heat treatment is carried out after formation of an electrode in manufacture of a device, and annealing process is carried out for activating doped impurities.

The present invention has been made in order to solve the foregoing problems. Accordingly, an object of the present invention is to provide a multilayer substrate in which temperature can be accurately detected in the process of performing the crystal-growth to form an oxide thin film on a translucent substrate or in the process of heat treatment.

### SUMMARY OF THE INVENTION

A first aspect of the present invention is to provide a multilayer substrate. The multilayer substrate has a translucent substrate being transparent in an infrared region, and a multilayer film containing one of an Au film and Pt film is formed on a translucent surface of the multilayer substrate. The principal surface is opposite to a principal surface on which a thin film containing oxygen in constituent elements is grown or thermally treated.

A second aspect of the present invention is to provide the multilayer substrate of the first aspect, in which the translucent substrate includes an oxide substrate for growing the thin film containing oxygen in the constituent elements.

A third aspect of the present invention is to provide the multilayer substrate of the first aspect, in which a dielectric film having one layer or multiple layers is provided between the translucent substrate and one of the Au film and the Pt film.

A fourth aspect of the present invention is to provide the multilayer substrate of the second aspect, in which a dielectric film having one layer or multiple layers is provided between the translucent substrate and one of the Au film and the Pt film.

The fifth aspect of the present invention is to provide the multilayer substrate of the third aspect, in which at least one layer of the dielectric film is formed of an oxide.

The sixth aspect of the present invention is to provide the multilayer substrate of the fourth aspect, in which at least one layer of the dielectric film is formed of an oxide.

A seventh aspect of the present invention is to provide the multilayer substrate of the third aspect, in which the dielectric film is formed so as to come in contact with one of the Au film and Pt film.

An eighth aspect of the present invention is to provide the multilayer substrate of the fourth aspect, in which the dielectric film is formed so as to come in contact with one of the Au film and Pt film.

A ninth aspect of the present invention is to provide the multilayer substrate of the fifth aspect, in which the dielectric film is formed so as to come in contact with one of the Au film and Pt film.

A tenth aspect of the present invention is to provide the multilayer substrate of the sixth aspect, in which the dielectric film is formed so as to come in contact with one of the Au film and Pt film.

An eleventh aspect of the present invention is to provide the multilayer substrate of the third aspect, in which the dielectric film is formed of NiO or TiO₂.

A twelfth aspect of the present invention is to provide the multilayer substrate of the fourth aspect, in which the dielectric film is formed of NiO or TiO₂.

A thirteenth aspect of the present invention is to provide the multilayer substrate of the fifth aspect, in which the dielectric film is formed of NiO or TiO₂.

A fourteenth aspect of the present invention is to provide the multilayer substrate of the sixth aspect, in which the dielectric film is formed of NiO or TiO₂.

A fifteenth aspect of the present invention is to provide the multilayer substrate of the seventh aspect, in which the dielectric film is formed of NiO or TiO₂.

A sixteenth aspect of the present invention is to provide the multilayer substrate of the eighth aspect, in which the dielectric film is formed of NiO or TiO₂.

A seventeenth aspect of the present invention is to provide the multilayer substrate of the ninth aspect, in which the dielectric film is formed of NiO or TiO₂.

An eighteenth aspect of the present invention is to provide the multilayer substrate of the tenth aspect, in which the dielectric film is formed of NiO or TiO₂.

The multilayer substrate of the present invention has a translucent substrate being transparent in an infrared region, and a multilayer film containing one of an Au film and Pt film is formed on a principal surface of the multilayer substrate. The principal surface is opposite to a principal surface on which a thin film containing oxygen in constituent elements is grown or thermally treated. Thus, the back metal, such as the Au film or Pt film, can cut excessive infrared light from the substrate holder or the heat source by reflecting or absorbing it. On the other hand, the temperature of the multilayer substrate per se can be measured by using infrared radiation form the back metal, such as the Au film or the Pt film. Thus, the substrate temperature can be accurately measured.

In addition, the dielectric film is provided between the translucent substrate and one of the Au film and Pt film. Thus, even when the translucent substrate is heated to be high temperature at the time when the oxide thin film is grown or thermally treated, the dielectric film can prevent Au or Pt in the Au film or Pt film from being dispersed. Accordingly, the function to reflect infrared light is not deteriorated.

### BRIEF DESCRIPTION OF DRAWINGS

FIG. 1 is a view showing the structure of a multilayer substrate of the present invention;

FIG. 2 is a view showing the configuration of measuring growth temperature when an oxide thin film is formed on the multilayer substrate of the present invention;

FIG. 3 is a view showing the configuration for measuring reflectance of a light beam;

FIG. 4 is a graph showing a relationship between wavelength and reflectance depending on the configuration of a back metal in the configuration of FIG. 3.

FIG. 5 is a graph showing a relationship between heating time and measured temperature of the multilayer substrate configured of a sapphire substrate, Au film, and NiO film in this order;

FIG. 6 is a graph showing a relationship between heating time and TC temperature of the multilayer substrate configured of a sapphire substrate, Au film, and NiO film in this order;

FIG. 7 is a graph showing a relationship between heating time and measured temperature of the multilayer substrate configured of a ZnO substrate, Au film, and NiO film in this order;

FIG. 8 is a graph showing a relationship between TC temperature and measured temperature of the multilayer substrate configured of a ZnO substrate, Au film, and NiO film in this order;

FIG. 9 is a graph showing a relationship between heating time and measured temperature of the multilayer substrate configured of a ZnO substrate, SiO₂ film, and NiO film in this order;

FIG. 10 is a graph showing a relationship between TC temperature and measured temperature of the multilayer substrate configured of a sapphire substrate, SiO₂ film, Au film, and NiO film in this order;

FIG. 11 is a graph showing a relationship between heating time and measured temperature of the multilayer substrate configured of a ZnO substrate, NiO film, Au film, and NiO film in this order;

FIG. 12 is a graph showing a relationship between TC temperature and measured temperature of the multilayer substrate configured of a sapphire substrate, NiO film, Au film, and NiO film in this order;

FIG. 13 is a view showing the conventional configuration of measuring growth temperature when an oxide thin film is formed on a translucent substrate; and

FIG. 14 is a view showing the conventional configuration of measuring growth temperature when an oxide thin film is formed on a translucent substrate.

### DETAILED DESCRIPTION OF THE INVENTION

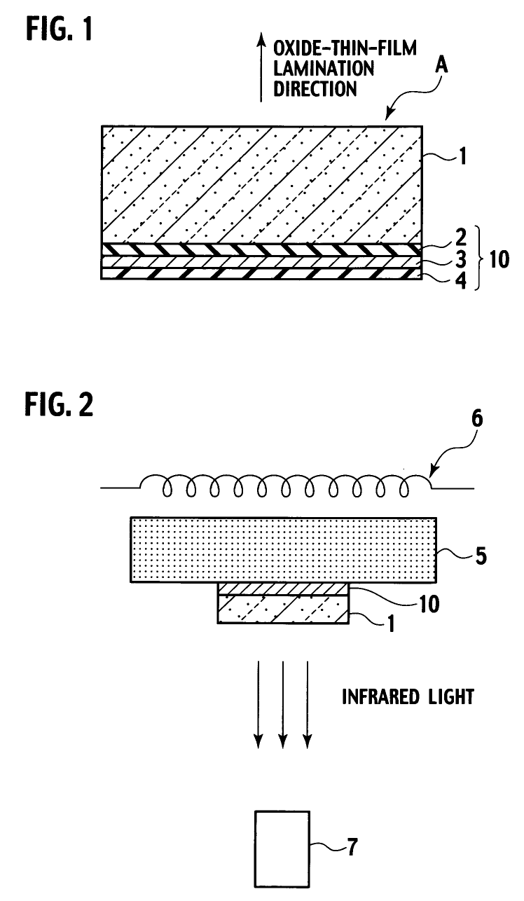

One embodiment of the present invention will be described below by referring to the drawings. FIG. 1 shows a cross-sectional structure of a multilayer substrate of the present invention.

The multilayer substrate has a translucent substrate 1 for carrying out the crystal growth to form an oxide thin film, which is one type of thin film containing oxygen in constituent elements. The multilayer substrate has the configuration in which a multilayer film 10 is formed on a principal surface thereof, which is opposite to a principal surface A in the oxide-thin-film lamination direction (a direction shown by arrows in the figure) in the translucent substrate 1. The multilayer film 10 is formed by sequentially laminating a dielectric film 2, an Au (gold) film 3, and an oxide film 4 from the translucent substrate 1. As the translucent substrate 1, for example, a substrate transparent in the infrared region, such as ZnO, sapphire, or SiON, is used but it may be a substrate in which an oxide thin film is disposed on these substrates.

In this manner, the following effects can be obtained with the multilayer film 10 containing Au in the multilayer substrate. FIG. 2 shows the configuration in which the multilayer substrate with the configuration of FIG. 1 is mounted on a substrate holder 5 and heated by a heat source 6, such as a heater, to be predetermined growth temperature. In addition, the substrate temperature at that time is measured by using an infrared thermometer 7 in FIG. 2.

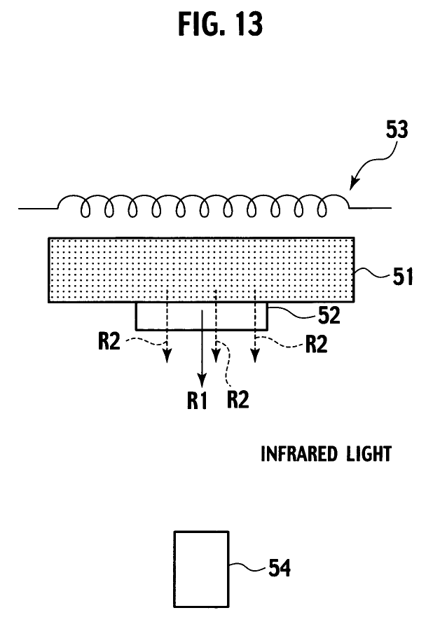

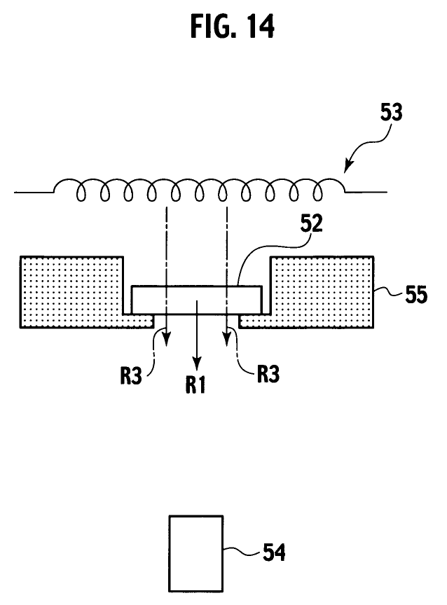

The multilayer film 10 containing an Au film is provided in the multilayer substrate in the direction opposite to the oxide-thin-film lamination direction so as to face the heat source 6 and the substrate holder 5. The oxide and the translucent substrate 1 are substantially transparent in the range from the visible light region to the wavelength of approximately 8 μm. However, the Au film 3 in the multilayer film 10 reflects or absorbs infrared light (R2 and R3 in FIGS. 13 and 14) radiating from the heat source 6 or the substrate holder 5, and thereby prevents the infrared light from transmitting through the multilayer substrate. As a result, only infrared light radiating from the back metal (Au film 3) enters the infrared thermometer 7, so that temperature can be accurately measured.

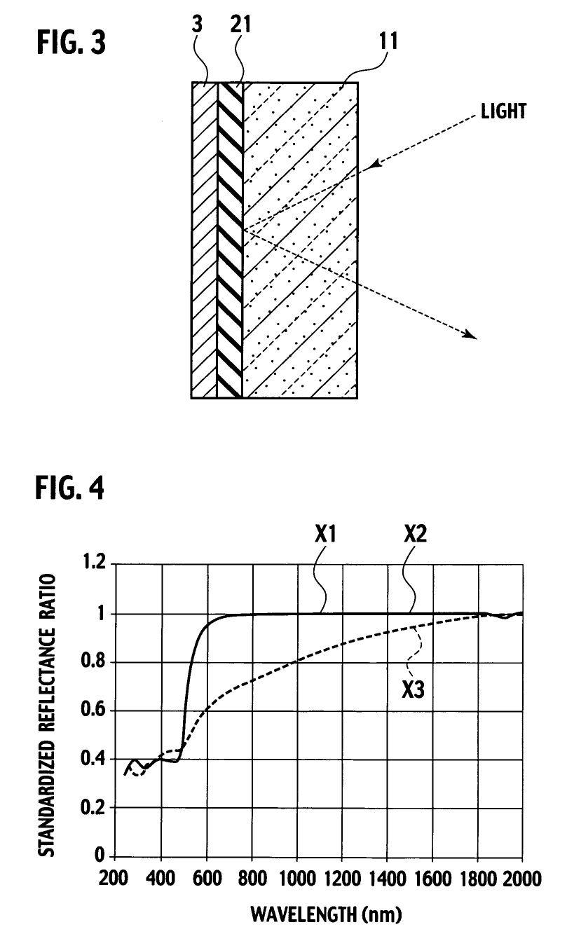

FIG. 3 is a configurational view for measuring what percentage of light transmitting through a sapphire substrate 11 is reflected in the following state. Specifically, in the state, the sapphire substrate 11 is used as the translucent substrate 1 of FIG. 1, a nickel oxide (NiO) film 21 is used as the dielectric film 2, and the oxide film 4 is not formed.

FIG. 4 is a graph showing results of measuring reflectance to respective wavelengths of light by using the above-described configuration. A measurement was carried out in relation to the light wavelengths in the range from 200 nm to 2000 nm. Then, the largest value of the reflectance was set to be 1 for normalization and the result was shown with standardized reflectance as the longitudinal axis. Reference numeral X1 shows the case described in FIG. 3. Reference numeral X2 shows the case where only the Au film 3 is formed on the sapphire substrate 11 except the nickel oxide film 21. Reference numeral X3 shows the case where the nickel (Ni) film is formed in place of the nickel oxide film 21. Note that X1 and X2 show the same curve, and thus drawn so as to be superimposed with each other.

As is clear from FIG. 4, in the case of X1 and X2 using Au as the back metal of the sapphire substrate 11, the value of the standardized reflectance is maintained at 1 in the infrared light region and thus reflectance is maintained extremely stable. However, in the case of X3 using Ni as the back metal, there is a case where reflectance changes depending on a wavelength in the infrared region, and the transmission amount of light is changed depending on the wavelength of the infrared light. Thus, even when the temperature is measured by the infrared thermometer in the configuration of FIG. 2, the temperature cannot be accurately measured.

As described above, Au is superior as the back metal for infrared light reflection. In addition, if an oxide thin film is formed on the translucent substrate 1, such as ZnO, sapphire, or SiON, the oxide thin film is formed in an oxygen atmosphere. Accordingly, an easily oxidized material, such as Ti, Ni, W, or Ta, cannot be used as the back metal reflecting the infrared light. Thus, a metal which is hardly oxidized and has resistance to the temperature exceeding 750°, such as Pt or Au, is suitable.

Thus, as the back metal, which reflects the infrared light, on the multilayer substrate, Au or Pt is desirable. Furthermore, following improvement was made. Since Au and Pt, which are the best as the back metal, are chemically stable, they are easily separated from the substrate. In addition, Au and Pt, particularly Au, have a characteristic of being dispersed very fast at relatively low temperature (500° or less) in almost any material.

According to this, a problem of forming holes in the Au film or the Pt film or damaging the film is caused by dispersion as a result of carrying out the crystal growth to form an oxide thin film with high temperature of, for example, 750° or more after Au or Pt is directly formed on the translucent substrate 1. The inventors of the present invention found that the dispersion is prevented by the dielectric film 2, such as an oxide film or nitride film.

Accordingly, as shown in FIG. 1, the dielectric film 2 is formed on the back surface of the translucent substrate 1, and then the Au film or the Pt film is further formed on the dielectric film 2. As the dielectric film 2, an oxide, such as NiO, SiO₂, TiO₂, or Cr₂O₃, or a nitride, such as AlN or SiN, is known. Generally, the nitride has high insulation properties. But, when the nitride is disposed in the atmosphere for crystal growth and exposed to high temperature as in the present invention, there is a possibility that oxidation proceeds with time. As a result, barrierability against dispersion may be deteriorated. Accordingly, it is desirable to use a stable oxide which hardly advances oxidation even at high temperature. Note that the dielectric film inserted between the translucent substrate 1 and one of the Au film and the Pt film may be formed by multiple layers in place of one layer. In addition, these metals are generally chemically stable, and are easily separated from the dielectric film or the like. However, as for the Au film, the inventors of the present invention found that the Au film 3 and the oxide film 4 are formed by using the annealing method (reverse annealing), which will be described later, so that they can be tightly adhered with each other. In addition, the Pt film may be oxidized by annealing by using a film having high chemical activeness, such as Ni, Ti, or Cr, as an adhesive.

As described above, when the multilayer substrate is heated for crystal growth to form the oxide thin film by causing the Au film 3 to be tightly adhered onto the dielectric film 2, the Au film 3 is heated with the same temperature as that of the translucent substrate 1. In addition, the Au film 3 per se radiates infrared light after cutting infrared light from an object behind the multilayer substrate. Thus, the temperature can be accurately detected by the infrared thermometer (pyrometer) . Accordingly, with the configuration of the present invention, the temperature can be accurately measured not only in the case of the crystal growth, but in a case where heat treatment is carried out. Note that the heat treatment includes annealing processing after forming an electrode or annealing processing for activating doped impurities.

In an experiment, measurement was carried out by setting infrared emittance e of the Au film 3 to be 0.5. As a result of the experiment, a value of the substrate temperature, which was the closest to the actual temperature, was obtained. Specifically, the multilayer substrate of FIG. 1 was configured of, for example, a ZnO film as the translucent substrate 1, a NiO film as the dielectric film 2, and a NiO film as the oxide film 4. The multilayer substrate with this configuration is formed as follows.

Firstly, a Ni film is formed by evaporation with the thickness of approximately 20 nm to 1000 nm on the back surface of the ZnO substrate as the translucent substrate 1. Subsequently, the ZnO substrate with Ni is disposed in the atmosphere containing 5% or more of oxygen and is heated at approximately 600° C. to 900° C. for approximately 10 to 30 minutes. After this process, Ni is oxidized, and the NiO film (dielectric film 2) in slightly greenish color is formed.

Thereafter, to the back surface on which the NiO film (dielectric film 2) is formed, a Ni film is laminated by evaporation with the thickness of 5 nm to 10 nm and an Au film is disposed on the Ni film by evaporation with the thickness of 100 nm to 1000 nm. Subsequently, in the atmosphere containing 1% or more of oxygen, a wafer having the configuration of the ZnO substrate, thermally-oxidized NiO film, Ni film, and Au film in this order is heated at approximately 500° C. to 800° C. for approximately 15 to 60 minutes. After this process, the Ni film and the Au film change their places, and the Ni film coming to the uppermost layer is oxidized by oxygen in the atmosphere (hereinafter referred to as reverse annealing).

In the above-described example, the multilayer substrate finally has the configuration of the ZnO substrate (translucent substrate 1), thermally-oxidized NiO film (dielectric film 2), Au film (Au film 3), and ultrathin NiO film (oxide film 4) in this order. The ZnO substrate is substantially transparent in the range from the visible light region to the wavelength of approximately 9 μm. Accordingly, a pyrometer (which measures infrared light of an object to be measured) monitoring substrate temperature generally measures the temperature of an object behind the ZnO substrate (for example, the heater itself or the substrate holder). However, with the above-described configuration, infrared light from the heater itself or the substrate holder is reflected. Thus, approximately only the infrared light from the Au film 3 is detected. As a result, the substrate temperature of the multilayer substrate can be accurately measured.

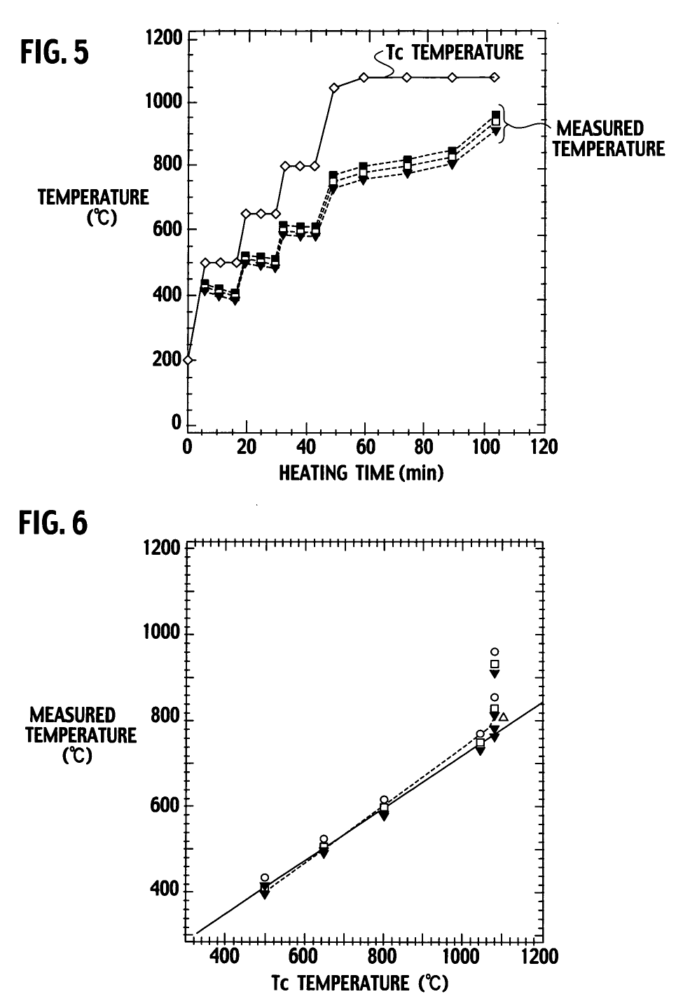

The foregoing description was validated by experiments. FIGS. 5 to 12 are graphs showing results of the experiments. FIGS. 5, 7, 9, and 11 are graphs, in each of which the horizontal axis is heating time of the multilayer substrate (unit is a minute) and the longitudinal axis is temperature. In addition, FIGS. 6, 8, 10 and 12 are graphs, in each of which the horizontal axis is actual temperature of the multilayer substrate (substrate temperature) and the longitudinal axis is measured temperature measured by an infrared thermometer (pyrometer)

The actual temperature of the multilayer substrate was measured by affixing an Au—Si film, Al—Si film, and Al film on the multilayer substrate by using an In film. The Au—Si film and the Al—Si film are mixed at 363° C. and 577° C., respectively (which is referred to as eutectic), and the Al film melts at 660° C. These values are thermodynamically determined and do not change depending on an experimental environment. Thus, the actual temperature can be calculated.

FIG. 5 shows actual temperature of the multilayer substrate and measured values measured by an infrared thermometer in a case where a sapphire substrate is used as the translucent substrate and the multilayer substrate is formed by the reverse annealing so as to have the configuration of the sapphire substrate, Au film, and NiO film in this order. In FIG. 5, rhomboids show thermocouple temperature Tc (equivalent to the actual temperature of the multilayer substrate) behind the substrate holder 5, black squares show values (measured values) obtained by setting the infrared emittance (thermal emittance) e of the Au film to be 0.4, white squares show values obtained by setting the infrared emittance e to be 0.5, and black inversed triangles show values obtained by setting the infrared emittance e to be 0.6. These values are measured by the infrared thermometer.

As the Tc temperature shown by the rhomboids increases with the heating time, and the measured values shown by the back squares, white squares, and black inversed triangles also increase. The Tc temperature and the measured values obtained from the experiment have the following relationship. Suppose a case where the Tc temperature is in the range from 500° C. to 800° C. In this case, the measured values are constant when the Tc temperature is a constant value. By contrast, think about a case where the Tc temperature is a high temperature of 1080° C. In this case, even if the TC temperature is maintained at 1080° C., the measured temperature increases with time (in the figure, at the region where the temperature is the highest in the graph of the rhomboids). In addition, as the elapsed time becomes longer, the measured temperature rapidly increases. That is, in the configuration of the sapphire substrate, Au film and NiO film in this order, the Au film is directly formed on the sapphire substrate (oxide layer), and thus the problem of forming holes in the Au film is caused by dispersion. As a result, monitoring could not be accurately carried out.

FIG. 6 is a graph in which the data of FIG. 5 is shown by using the measured temperature measured by the infrared thermometer as the longitudinal axis and the Tc temperature as the horizontal axis. Here, white circles show the case where the infrared emittance (thermal emittance) e of the Au film is 0.4, white squares show the case where e is 0.5, and black inversed triangles show the case where e is 0.6. The relationship between the Tc temperature and the measured values maintains linearity (proportional relation) in the range from approximately 300° C. to 900° C. However, around the temperature exceeding 900° C., the linearity cannot be seen. For example, at 1080° C., it can be seen that a large volume of data become widely present with time and the measured temperature is increased.

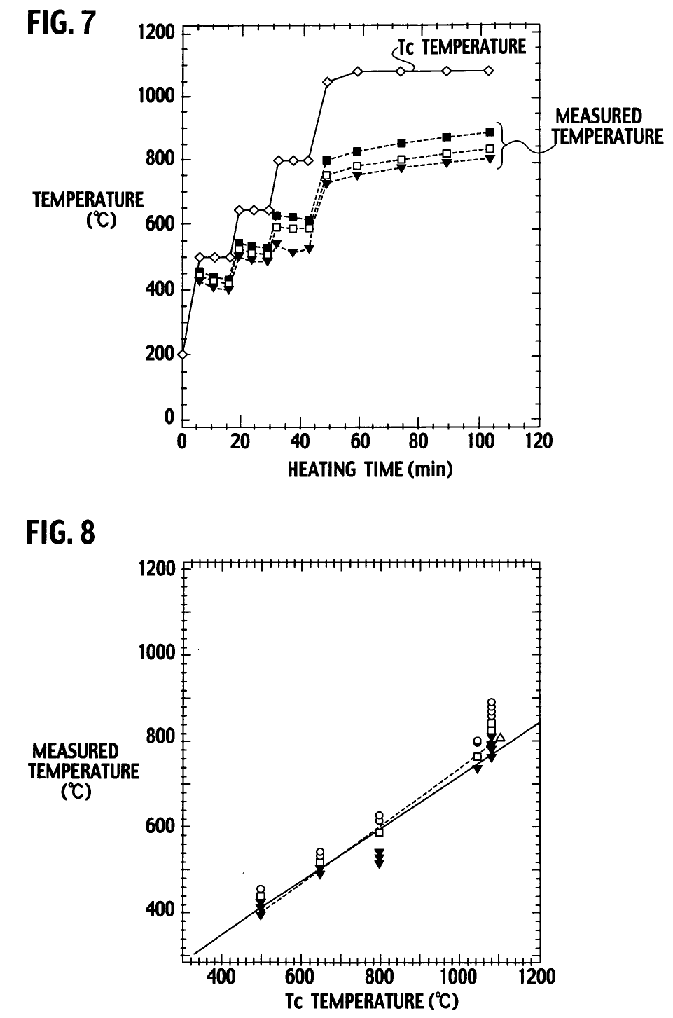

An experiment was carried out by using a ZnO substrate as the translucent substrate, and the multilayer substrate that is formed by the reverse annealing so as to have the configuration of the ZnO substrate, Au film, and NiO film in this order was similarly measured. FIG. 7 shows results of the experiment. In FIG. 7, in a case where the temperature of the multilayer substrate is changed depending on the heating time, the actual temperature of the multilayer substrate (substrate temperature) and the measured values measured by the infrared thermometer are shown. In FIG. 7, rhomboids show Tc temperature, black squares show values obtained by setting infrared emittance (thermal emittance) e of the Au film to be 0.4, white squares show values obtained by setting e to be 0.5, and black inversed triangles show values obtained by setting e to be 0.6. These values are measured by the infrared thermometer.

The Tc temperature and the measured values obtained from the experiment have the following relationship. Suppose a case where the Tc temperature is in the range from 500° C. to 800° C. In this case, the measured values are constant when the Tc temperature is a constant value. By contrast, think about a case where the Tc temperature is a high temperature of 1080° C. In this case, even if the TC temperature is maintained at 1080° C., the measured temperature increases with time (in the figure, at the region where the temperature is the highest in the graph of the rhomboids) by approximately 50° C. from the initial temperature at the time when the Tc temperature became 1080° C. Similar to the case described in FIG. 5, this is because in the configuration in which the ZnO substrate, the Au film and the NiO film are formed in this order, the Au film is directly formed on the ZnO substrate (oxide layer), and thus the problem of forming holes in the Au film is caused by dispersion. As a result, monitoring cannot be accurately carried out.

FIG. 8 is a graph in which the measured temperature is shown in the longitudinal axis and the Tc temperature is shown in the vertical axis. In the experiment of FIG. 8, the multilayer substrate having the configuration of the ZnO substrate, Au film, and NiO film, which is used in the experiment of FIG. 7, was used and the settings of the infrared emittance e were changed. Here, white circles show values obtained by setting the infrared emittance (thermal emittance) e of the Au film to be 0.2, white squares show values obtained by setting e to be 0.3, and black inversed triangles show values obtained by setting e to be 0.4. These values are measured by the infrared thermometer. The relationship between the Tc temperature and the measured values maintains linearity (proportional relation) in the range from approximately 300° C. to 900° C. However, around the temperature exceeding 900° C., the linearity cannot be seen. For example, at 1080° C., it can be seen that a large volume of data become widely present with time and the measured temperature is increased.

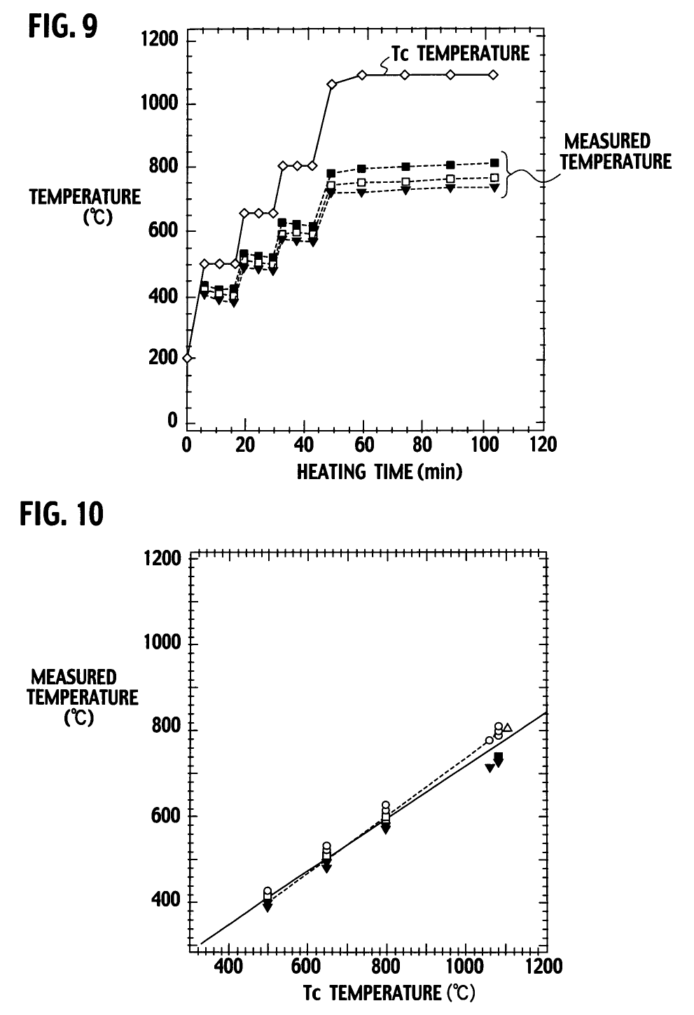

In FIG. 9, a ZnO substrate was used as a translucent substrate and measurement was carried out after the following processes were carried out thereon. Specifically, after a SiO₂ film as a dielectric film is formed on this ZnO substrate, the multilayer substrate is made by the reverse annealing so as to have the configuration of the ZnO substrate, SiO₂ film, Au film, and NiO film in this order. FIG. 9 shows results of the experiment. In FIG. 9, rhomboids show Tc temperature, black squares show values obtained by setting infrared emittance (thermal emittance) e of the Au film to be 0.2, white squares show values obtained by setting e to be 0.3, and black inversed triangles show values obtained by setting e to be 0.4. These values are measured by the infrared thermometer.

Here, when the Tc temperature is in the range form 500° C. to 800° C., the measured values are also constant with the Tc temperature being a constant value. However, when the Tc temperature becomes high temperature of 1080° C. and is maintained at 1080° C., the measured temperature shown by the black squares, white squares, and black inversed triangles slightly increase by 13° C., which is from 752° C. to 765° C. That is, there is almost no change with time.

In FIG. 9, a sapphire substrate was used as a translucent substrate and measurement was carried out after the following processes were carried out thereon. Specifically, after a SiO₂ film as a dielectric film is formed on this sapphire substrate, the multilayer substrate is made by the reverse annealing so as to have the configuration of the sapphire substrate, SiO₂ film, Au film, and NiO film in this order. FIG. 10 shows results of the experiment. In FIG. 10, the relationship between the measured temperature measured by the infrared thermometer and the Tc temperature is shown. The longitudinal axis shows the measured temperature and the horizontal axis shows the Tc temperature. Here, white circles show values obtained by setting the infrared emittance (thermal emittance) e of the Au film to be 0.2, white squares show values obtained by setting e to be 0.3, and black inversed triangles show values obtained by setting e to be 0.4. These values are measured by the infrared thermometer.

The relationship between the Tc temperature and the measured values maintains linearity (proportional relation) in the range from approximately 300° C. to 900° C. Moreover, even when the temperature exceeds 900° C., the linearity is relatively well-maintained, and variation of data at the Tc temperature of 1080° C. is not large. Accordingly, even if the sapphire substrate is used, the dispersion of Au can be prevented by the SiO₂ film (dielectric film).

In this manner, it can be seen that the dielectric film 2, such as the SiO₂ film, is inserted between the translucent substrate 1, such as the ZnO substrate or sapphire substrate (Al₂O₃), and the Au film 3, so that the dispersion of Au can be prevented and thus temperature can be accurately measured.

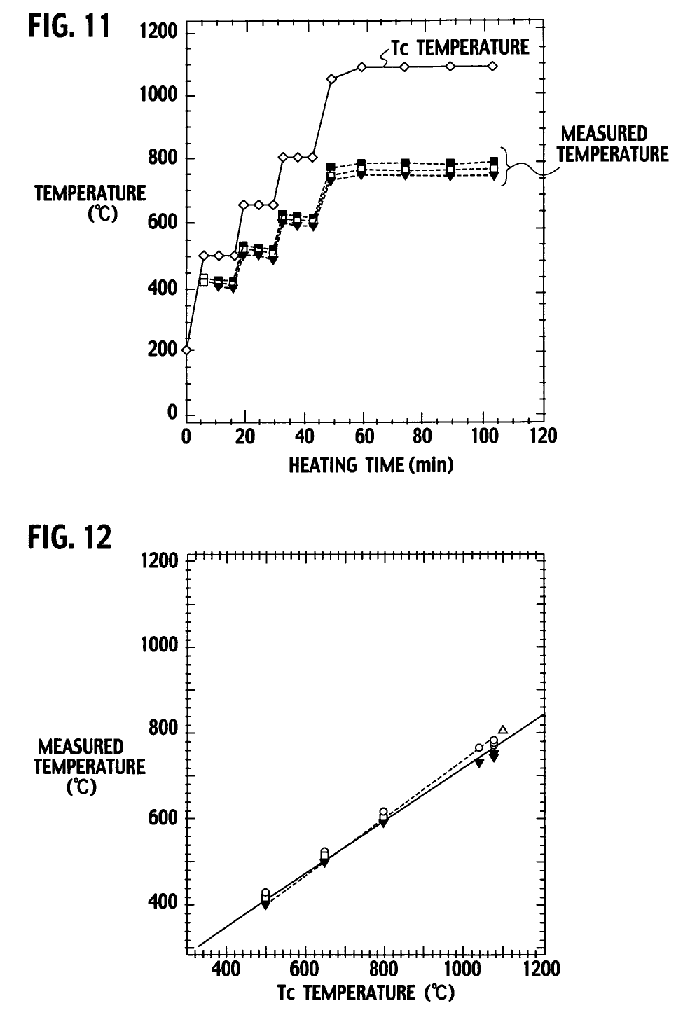

An experiment was carried out by using a ZnO substrate as a translucent substrate, and after forming an NiO film, in place of an SiO₂ film, on this ZnO substrate as a dielectric film, the multilayer substrate that is formed by the reverse annealing on the NiO film so as to have the configuration of the ZnO substrate, NiO film, Au film, and NiO film in this order was similarly measured. FIG. 11 shows results of the experiment. In FIG. 11, rhomboids show Tc temperature, which is the actual temperature of the multilayer substrate, black squares show values obtained by setting infrared emittance (thermal emittance) e of the Au film to be 0.4, white squares show values obtained by setting e to be 0.5, and black inversed triangles show values obtained by setting e to be 0.6. These values are measured by the infrared thermometer.

Here, in the case where the Tc temperature is not only in the range from 500° C. to 800° C. but in high temperature of 1080° C. and is maintained at 1080° C., the measured temperature shown by the back squares, white squares, and black inversed triangles hardly change with time. Note that the change of the measured temperature from the temperature at the time when the Tc temperature initially reached at 1080° C. was from 761° C. to 762° C. Accordingly, this is extremely preferable than the case where the SiO₂ film was used as the dielectric film like the case described in FIG. 9.

An experiment was carried out by using a sapphire substrate as a translucent substrate, and after forming an NiO film on this sapphire substrate as a dielectric film, the multilayer substrate that is formed by the reverse annealing on the NiO film so as to have the configuration of the sapphire substrate, SiO₂ film, NiO film, Au film, and NiO film in this order was heated. FIG. 12 shows results of the experiment. In FIG. 12, white circles show values obtained by setting the infrared emittance (thermal emittance) e of the Au film to be 0.5, white squares show values obtained by setting e to be 0.6, and black inversed triangles show values obtained by setting e to be 0.7. These values are measured by the infrared thermometer.

Similar to the case described in FIG. 11, in the case where the Tc temperature is not only in the range from 500° C. to 800° C. but in high temperature of 1080° C. and is maintained at 1080° C., the measured temperature shown by the back squares, white squares, and black inversed triangles hardly change with time. This is more preferable than the case where the SiO₂ film was formed as the dielectric film like the case described in FIG. 10.

When the results of the above-described experiments are summed up, as the dielectric film 2 to be provided between the translucent substrate 1 and one of the Au film 3 or the Pt film, a NiO film becomes most desirable. Moreover, when Au is used as the back metal, the adhesiveness between a base layer, such as the dielectric film 2, and the Au film 3 becomes extremely well by the reverse annealing. Accordingly, it is preferable to have the configuration of an oxide layer, NiO film, Au film, and NiO film in this order.

In addition, if a Pt film is used in place of an Au film in the above-described configuration, a Ti film with the thickness of 5 nm to 100 nm is firstly formed on a translucent substrate 1, and subsequently the Pt film is formed with the thickness of 100 nm to 1000 nm by evaporation. Thereafter, the annealing processing is carried out on the multilayer substrate at 700° C. or more, so that oxygen is dispersed from the translucent substrate 1 to cause the Ti film to be a TiO₂ (titanium oxide) film. As a result, the configuration formed of the translucent substrate 1, TiO₂ (dielectric film 2), and Pt film in this order can be obtained. Accordingly, effects similar to those of the case where the Au film is used can be obtained. Note that if an oxide layer is not used as a substrate for growth, the above-described reverse annealing may be carried out similar to the case of Au.

A method for forming an oxide thin film on a multilayer substrate as shown in FIG. 1 will be described below. As a translucent substrate 1 and an oxide thin film, a ZnO based semiconductor is used. Here, the ZnO-based material is a mixed crystal material using ZnO as a base, and is a material in which one part of Zn is replaced with an element in IIA or IIB family or one part of O is replaced with an element in VIB family, or is the combination of the both. Then, the multilayer substrate is formed with the configuration of, for example, a ZnO substrate, NiO film, Au film, and NiO film.

The ZnO substrate which is 0.5 degree off in the M direction is used to set the principal surface of the multilayer substrate to be 0.5 degree off in the M direction. This multilayer substrate is put in a load lock chamber, and to remove water therefrom, the multilayer substrate is heated at 200° C. for approximately 30 minutes under the vacuum environment of approximately 1×10⁻⁵ Torr to 1×10⁶ Torr. Then, the substrate is introduced into a growth chamber with a wall surface chilled by liquid nitrogen through a conveyance chamber with the vacuum of approximately 1×10⁻⁹ Torr, so that a ZnO based thin film is grown on the principal surface A side in FIG. 1 by using the MBE method.

By heating a Knudsen cell to be approximately 260° C. to 280° to be sublimated, Zn is supplied as Zn molecular beams. In the Knudsen cell, high-purity Zn with 7 N is put in a crucible formed of pBN. One example of the IIA family elements is Mg, and Mg is also supplied as Mg molecular beams by heating high-purity Mg with 6 N in a cell having a similar cell structure at 300° C. to 400° C. to be sublimated. As oxygen, an O₂ gas with 6 N is used and supplied to a RF radical cell with approximately 0.1 sccm to 5 sccm. The RF radical cell includes a cylindrical discharging tube in which small orifices are opened in one portion thereof through a SUS tube with an electrobrightening inner surface. Then, the RF high-frequency of approximately 100 W to 300 W is applied to generate plasmas. The generated plasmas are caused to be O radical in which reaction activity is increased and supplied as an oxygen source. The plasmas are important, and even if an O₂ raw gas is added, a ZnO-based thin film is not formed.

For the substrate, if general resistance heating is performed, a carbon heater coated with SiC is used. Metal-based heaters, the metal is for example W, cannot be used because they are oxidized. In addition, there is a heating method using lamp heating, laser heating and the like. However, the heating method can be any method as long as it has resistance to oxidation.

After heating up to 750° C. or more for approximately 30 minutes under the vacuum of approximately 1×10⁻⁹ Torr, shutters of the radical cell and the Zn cell are opened to start the growth of the ZnO thin film. At this time, to obtain a flat film, the substrate temperature should be 750° C. or more regardless of which kind of film is formed.

In this manner, the present invention of course includes various embodiments which are not described herein. Accordingly, the technical scope of the present invention is only defined by claims that are properly based on the foregoing description.

What is claimed:

1. A multilayer substrate comprising:
a translucent substrate being transparent in an infrared region; and
a multilayer film containing one of an Au film and a Pt film, and being formed on a first principal surface of the translucent substrate, the first principal surface being opposite to a principal surface on which a thin film containing oxygen as a constituent element is grown and thermally treated in the translucent substrate.

2. The multilayer substrate of claim 1, wherein the translucent substrate includes an oxide substrate for growing the thin film containing oxygen as the constituent element.

3. The multilayer substrate of claim 1, wherein the multilayer film includes one of a dielectric film having one layer and a dielectric film having a plurality of layers, between the translucent substrate and one of the Au and the Pt film.

4. The multilayer substrate of claim 2, wherein the multilayer film includes one of a dielectric film having one layer and a dielectric film having a plurality of layers, between the translucent substrate and one of the Au and the Pt film.

5. The multilayer substrate of claim 3, wherein at least one layer of the dielectric film is formed of an oxide.

6. The multilayer substrate of claim 4, wherein at least one layer of the dielectric film is formed of an oxide.

7. The multilayer substrate of claim 3, wherein the dielectric film is formed to come in contact with one of the Au film and the Pt film.

8. The multilayer substrate of claim 4, wherein the dielectric film is formed to come in contact with one of the Au film and the Pt film.

9. The multilayer substrate of claim 5, wherein the dielectric film is formed to come in contact with one of the Au film and the Pt film.

10. The multilayer substrate of claim 6, wherein the dielectric film is formed to come in contact with one of the Au film and the Pt film.

11. The multilayer substrate of claim 3, wherein the dielectric film is formed one of NiO and TiO₂.

12. The multilayer substrate of claim 4, wherein the dielectric film is formed of one of NiO and TiO₂.

13. The multilayer substrate of claim 5, wherein the dielectric film is formed of one of NiO and TiO₂.

14. The multilayer substrate of claim 6, wherein the dielectric film is formed of one of NiO and TiO₂.

15. The multilayer substrate of claim 7, wherein the dielectric film is formed of one of NiO and TiO₂.

16. The multilayer substrate of claim 8, wherein the dielectric film is formed of one of NiO and TiO₂.

17. The multilayer substrate of claim 9, wherein the dielectric film is formed of one of NiO and TiO₂.

18. The multilayer substrate of claim 10, wherein the dielectric film is formed of one of NiO and TiO₂.
